(19) United States
(12) Patent Application Publication
(10) Pub. No.: US 2026/0151794 A1
(43) Pub. Date: Jun. 4, 2026

(54) TACTILE SENSATION PRESENTING DEVICE

(71) Applicant: Sharp Display Technology Corporation, Kameyama City (JP)

(72) Inventors: Kohhei TANAKA, Kameyama City (JP); Tomonori YOSHIDA, Kameyama City (JP)

(21) Appl. No.: 19/407,776

(22) Filed: Dec. 3, 2025

(30) Foreign Application Priority Data
Dec. 4, 2024 (JP) 2024-211657

(51) Int. Cl. B06B 1/02; B06B 1/06; G06F 3/01

(52) U.S. Cl. CPC B06B 1/0215; B06B 1/0662; G06F 3/016; B06B 2201/55

(57) ABSTRACT

A tactile sensation presenting device has a plurality of unit regions in each of which presentation of tactile sensations can be independently controlled. The tactile sensation presenting device includes: a tactile sensation presenting section provided in each of the unit regions, the tactile sensation presenting section being capable of presenting tactile sensations; and a unit circuit electrically coupled with the tactile sensation presenting section, the unit circuit being capable of driving the tactile sensation presenting section. The unit circuit includes a plurality of sub-circuits electrically coupled in parallel with one another. Each of the sub-circuits includes a first internal node, and a first capacitor having a first end electrically coupled with the first internal node and a second end electrically coupled with the tactile sensation presenting section. The tactile sensation presenting device controls an applied voltage to the tactile sensation presenting section or an electric current flowing through the tactile sensation presenting section by controlling a potential of the first internal node in each of the sub-circuits.

### BACKGROUND

### 1. Technical Field

The present invention relates to tactile sensation presenting devices.

### 2. Description of the Related Art

In recent years, tactile sensation presenting devices capable of presenting tactile sensations to a user (also referred to as “haptics devices”) have been receiving attention and have already been applied to a variety of uses, such as medical, educational, entertainment, and remote operation uses. Several types of tactile sensation presenting devices have been known.

A type of tactile sensation presenting device that is configured to present tactile sensations by transmitting vibration to a user, i.e., vibrational stimulation, (hereinafter, referred to as “vibration type”) is one of the most promising types because of small individual differences in tactile sensitivity and high safety. A vibration type tactile sensation presenting device is disclosed in, for example, Japanese Laid-Open Patent Publication No. 2012-128499.

The vibration type tactile sensation presenting device presents tactile sensations by generating vibration by an actuator while a specific portion of the human body (e.g., finger) is in contact with the tactile sensation presenting device. Note that, in this specification, a part of a tactile sensation presenting device which actually presents tactile sensations, such as an actuator in a vibration type device, may also be referred to as “tactile sensation presenting section”. As the actuator, for example, a piezoelectric element is used.

However, in general, to generate sufficiently strong vibrations using a piezoelectric element, it is necessary to apply high voltages at several tens of volts or higher to the piezoelectric element. To realize multi-level tactile sensation presentation, a specialized driver IC compatible with the high voltages is necessary, and such a driver IC leads to an increased manufacturing cost.

Embodiments of the present invention were conceived in view of the above-described problems and are directed to providing tactile sensation presenting devices that can be realized at a reduced manufacturing cost even when the tactile sensation presenting section requires application of relatively high voltages.

### SUMMARY

This specification discloses tactile sensation presenting devices described in the following items.

### [Item 1]

A tactile sensation presenting device having a plurality of unit regions in each of which presentation of tactile sensations can be independently controlled, the device comprising:
a tactile sensation presenting section provided in each of the plurality of unit regions, the tactile sensation presenting section being capable of presenting tactile sensations; and
a unit circuit electrically coupled with the tactile sensation presenting section, the unit circuit being capable of driving the tactile sensation presenting section,
wherein the unit circuit includes a plurality of sub-circuits electrically coupled in parallel with one another,
each of the plurality of sub-circuits includes
   a first internal node, and
   a first capacitor having a first end electrically coupled with the first internal node and a second end electrically coupled with the tactile sensation presenting section, and
an applied voltage to the tactile sensation presenting section or an electric current flowing through the tactile sensation presenting section is controlled by controlling a potential of the first internal node in each of the plurality of sub-circuits.

### [Item 2]

The tactile sensation presenting device of Item 1, wherein each of the plurality of sub-circuits further includes
a second internal node,
a first transistor having a source and a drain, one of the source and the drain being supplied with a data voltage having a predetermined amplitude while the other being electrically coupled with the second internal node, and
a second transistor having a gate, a source and a drain, the gate being electrically coupled with the second internal node, one of the source and the drain being supplied with a driving voltage having a greater amplitude than that of the data voltage while the other being electrically coupled with the first internal node.

### [Item 3]

The tactile sensation presenting device of Item 2, wherein each of the plurality of sub-circuits further includes a second capacitor having a first end electrically coupled with the second internal node and a second end electrically coupled with the first internal node.

### [Item 4]

The tactile sensation presenting device of Item 2 or 3, wherein each of the plurality of sub-circuits further includes a third transistor having a source and a drain, one of the source and the drain being electrically coupled with the first internal node while the other being electrically coupled with a reference voltage source.

### [Item 5]

The tactile sensation presenting device of Item 2 or 3, wherein each of the plurality of sub-circuits does not include a transistor for resetting the first internal node.

### [Item 6]

The tactile sensation presenting device of any of Items 2 to 5, wherein the unit circuit further includes a fourth transistor having a source and a drain, one of the source and the drain being electrically coupled with the second end of the first capacitor of each of the plurality of sub-circuits while the other being electrically coupled with a reference voltage source.

### [Item 7]

The tactile sensation presenting device of any of Items 2 to 6, wherein the first transistors of the plurality of sub-circuits are supplied with the data voltage from a common data voltage line.

### [Item 8]

The tactile sensation presenting device of any of Items 2 to 6, wherein the first transistors of the plurality of sub-circuits are supplied with the data voltage from different data voltage lines.

### [Item 9]

The tactile sensation presenting device of any of Items 2 to 8, wherein
the driving voltage supplied to the second transistor is a pulse voltage, and
a frequency of the pulse voltage is variable.

### [Item 10]

The tactile sensation presenting device of any of Items 2 to 9, wherein
the tactile sensation presenting device has a tactile sensation presenting region including the plurality of unit regions, and
the tactile sensation presenting region includes a plurality of regions among which the driving voltage supplied to the second transistor can be different.

### [Item 11]

The tactile sensation presenting device of any of Items 2 to 10, wherein each of the first transistor and the second transistor is an oxide semiconductor TFT including an oxide semiconductor layer.

### [Item 12]

The tactile sensation presenting device of any of Items 1 to 11, wherein the first capacitors of the plurality of sub-circuits have equal capacitance values.

### [Item 13]

The tactile sensation presenting device of any of Items 1 to 11, wherein the first capacitors of the plurality of sub-circuits have different capacitance values.

### [Item 14]

The tactile sensation presenting device of any of Items 1 to 13, wherein the plurality of sub-circuits included in the unit circuit are three or more sub-circuits.

### [Item 15]

The tactile sensation presenting device of any of Items 1 to 14, wherein the tactile sensation presenting section includes
a vibrator layer, and
a first electrode and a second electrode located opposite to each other with the vibrator layer interposed therebetween.

### [Item 16]

The tactile sensation presenting device of Item 15, wherein the vibrator layer is a piezoelectric layer that is made of a piezoelectric material.

### [Item 17]

The tactile sensation presenting device of any of Items 1 to 14, wherein the tactile sensation presenting section is capable of presenting tactile sensations by electrical stimulation.

According to embodiments of the present invention, tactile sensation presenting devices can be provided that can be realized at a reduced manufacturing cost even when the tactile sensation presenting section requires application of relatively high voltages.

### BRIEF DESCRIPTION OF THE DRAWINGS

FIG. 1 is a block diagram schematically showing a tactile sensation presenting device 100 according to an embodiment of the present invention.

FIG. 2 is diagram for illustrating a fingertip inner portion fp.

FIG. 3 is a plan view schematically showing a tactile sensation presenting element 1 included in the tactile sensation presenting device 100.

FIG. 4 is a diagram showing the equivalent circuit of a unit region UR of the tactile sensation presenting element 1.

FIG. 5 is a diagram showing an arrangement example of data voltage lines DL and gate signal lines GL.

FIG. 6 is a graph showing the relationship between the presented levels and the applied voltage Vpz to the tactile sensation presenting section 10 in the case of Vp=62 [V], Cpz=15 [pF], and Cst=60 [pF].

FIG. 7 is a timing chart showing an example of the driving voltage Vp, the gate signals S1, S2, S3, and the initialization signal Sini.

FIG. 8A is a diagram for illustrating the operation of the tactile sensation presenting device 100 (the tactile sensation presenting element 1).

FIG. 8B is a diagram for illustrating the operation of the tactile sensation presenting device 100 (the tactile sensation presenting element 1).

FIG. 8C is a diagram for illustrating the operation of the tactile sensation presenting device 100 (the tactile sensation presenting element 1).

FIG. 9 is a graph showing the relationship between the applied voltage Vpz to the tactile sensation presenting section 10 and the data writing period.

FIG. 10 is a diagram showing the equivalent circuit of a unit region UR of the tactile sensation presenting element 1A.

FIG. 11 is a diagram showing an arrangement example of data voltage lines DL and gate signal lines GL in the tactile sensation presenting element 1A.

FIG. 12 is a timing chart showing an example of the driving voltage Vp, the gate signals S, and the initialization signal Sini in the tactile sensation presenting element 1A.

FIG. 13 is a diagram showing the equivalent circuit of a unit region UR of the tactile sensation presenting element 1B.

FIG. 14 is a graph showing the relationship between the presented levels and the applied voltage Vpz to the tactile sensation presenting section 10 in the case of Vp=62 [V], Cpz=15 [pF], and Cs′=60 [pF] in the tactile sensation presenting element 1B.

FIG. 15 is a diagram showing the equivalent circuit of a unit region UR of the tactile sensation presenting element 1C.

FIG. 16 is a timing chart showing an example of the driving voltage Vp, the gate signals S, the initialization signal Sini, and the data voltage Vd in the tactile sensation presenting element 1C.

FIG. 17 is a diagram showing an example where the frequency of the driving voltage Vp, which is a pulse voltage, changes.

FIG. 18 is a diagram showing an example of the active region AR including a plurality of regions that can have different driving voltages Vp.

FIG. 19 is a diagram showing another example of the active region AR including a plurality of regions that can have different driving voltages Vp.

FIG. 20 is a diagram showing an electrical stimulation type tactile sensation presenting device 200.

### DETAILED DESCRIPTION

Hereinafter, embodiments of the present invention are described with reference to the drawings. Note that the present invention is not limited to the embodiments described below.

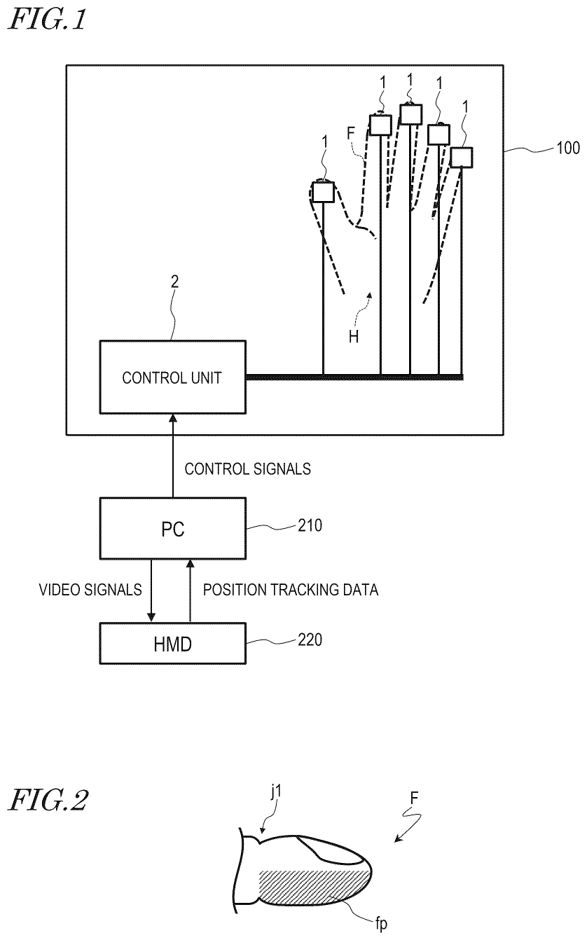

A tactile sensation presenting device 100 according to an embodiment of the present invention is described with reference to FIG. 1. FIG. 1 is a block diagram schematically showing the tactile sensation presenting device 100. FIG. 1 also shows a personal computer (PC) 210 and a head mounted display (HMD) 220 in addition to the tactile sensation presenting device 100.

As shown in FIG. 1, the tactile sensation presenting device 100 includes at least one tactile sensation presenting element 1 and a control unit 2 that is capable of controlling the tactile sensation presenting element 1. In the illustrated example, the tactile sensation presenting device 100 includes a plurality of tactile sensation presenting elements 1, more specifically five tactile sensation presenting elements 1. Note that the number of tactile sensation presenting elements 1 is not limited to five.

When the tactile sensation presenting device 100 is used, the five tactile sensation presenting elements 1 are provided so as to be in contact with the fingertips of five fingers F of a user's hand H (drawn by broken lines in FIG. 1). Each of the tactile sensation presenting elements 1 presents tactile sensations by vibrational stimulation to the fingertip inner portion of a single finger F. Herein, the “fingertip inner portion” refers to a part fp of the finger F which is located beyond the first joint (distal joint) j1 of the finger F and which is located on the palm side relative to the center when the finger F is viewed from the side as shown in FIG. 2.

The control unit 2 controls the tactile sensation presenting elements 1. The control unit 2 controls the tactile sensation presenting elements 1 based on control signals transmitted from the PC 210. The data transmission between the control unit 2 and the PC 210 may be realized by wireless communication or wired communication. The wireless communication and wired communication can be established in compliance with various known communication standards. The control unit 2 is realized by, for example, a microcomputer.

The tactile sensation presenting elements 1 are wired using flexible boards, wires, and the like, so as not to obstruct the movement of the hand H. The control unit 2 can be provided at, for example, a portion corresponding to a user's arm. The tactile sensation presenting elements 1 and the control unit 2 may be integrated in the form of a glove.

The PC 210 outputs video signals to the HMD 220, and the HMD 220 displays a video based on the received video signals. The HMD 220 also outputs position tracking data, which is information about the position of the HMD 220, and the like, to the PC 210. The data transmission between the PC 210 and the HMD 220 may be realized by wireless communication or wired communication.

Note that, in the example described herein, the tactile sensation presenting device 100 presents tactile sensations in conjunction with a video displayed by the HMD 220, although the use of the tactile sensation presenting device 100 is not limited to this example.

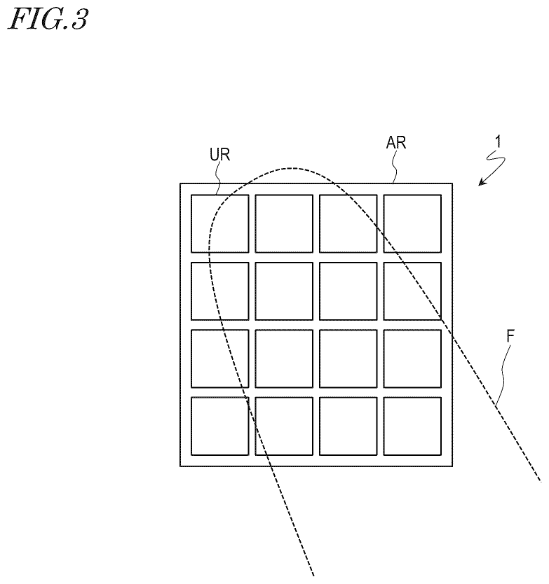

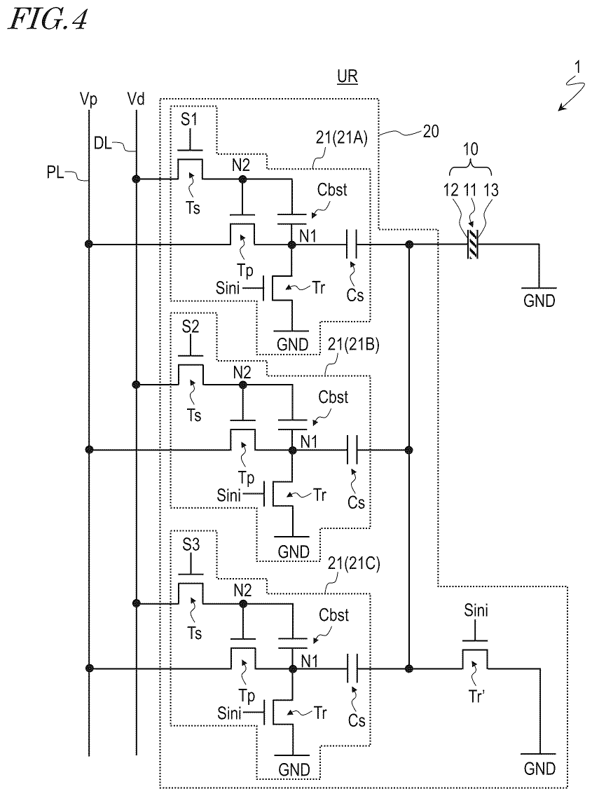

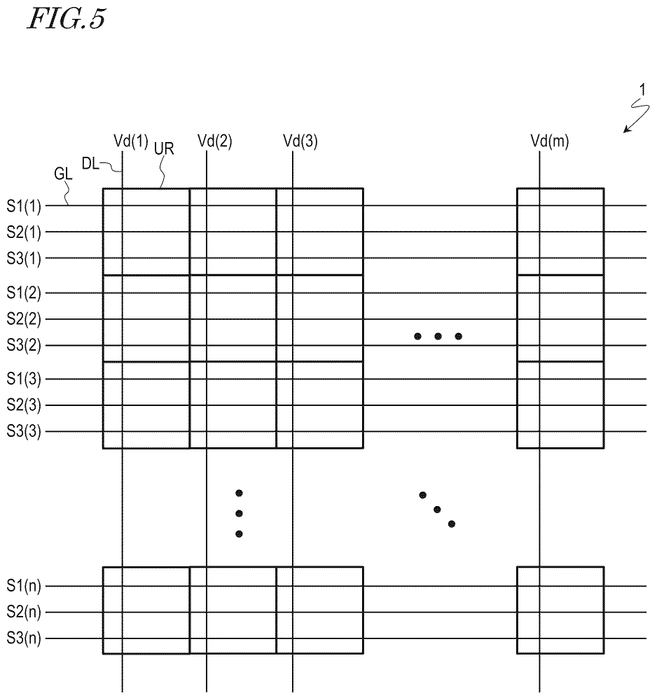

A specific configuration of the tactile sensation presenting element 1 is described with reference to FIG. 3 and FIG. 4. FIG. 3 is a plan view schematically showing the tactile sensation presenting element 1. FIG. 4 is a diagram showing the equivalent circuit of a unit region UR of the tactile sensation presenting element 1.

As shown in FIG. 3, the tactile sensation presenting element 1 includes a plurality of unit regions UR in each of which presentation of tactile sensations is independently controlled. In the illustrated example, the plurality of unit regions UR are arrayed in a matrix consisting of a plurality of rows and a plurality of columns. Note that, in the example shown in FIG. 3, the number of unit regions UR is 16, although the number of unit regions UR is not limited to this example. Also, the array of the plurality of unit regions UR is not limited to the example shown in FIG. 3. The plurality of unit regions UR may be arrayed in a single row and a plurality of columns or in a plurality of rows and a single column. Also, in the illustrated example, the shape of the unit regions UR is generally rectangular, although the shape of the unit regions UR is not limited to this example.

The plurality of unit regions UR define a tactile sensation presenting region (hereinafter, also referred to as “active region”) AR. That is, the tactile sensation presenting element 1 has the active region AR that includes the plurality of unit regions UR. Note that, although not shown herein, the tactile sensation presenting element 1 may further have a peripheral region (frame region) located so as to surround the active region AR. Also, in the illustrated example, the active region AR has a generally rectangular shape, although the shape of the active region AR is not limited to the generally rectangular shape.

As shown in FIG. 4, the tactile sensation presenting element 1 includes a tactile sensation presenting section 10 provided in each of the plurality of unit regions UR and a unit circuit 20 electrically coupled with the tactile sensation presenting section 10.

The tactile sensation presenting section 10 is a portion of the tactile sensation presenting element 1 which is configured to present tactile sensations. Herein, the tactile sensation presenting section 10 includes a vibrator layer 11, and a first electrode 12 and a second electrode 13 located opposite to each other with the vibrator layer 11 interposed therebetween.

The vibrator layer 11 undergoes physical deformation according to the applied voltage or applied current to generate vibration. Herein, the vibrator layer 11 is a piezoelectric layer that is made of a piezoelectric material. The piezoelectric material can be selected from a variety of known piezoelectric materials. For example, piezoelectric ceramic materials, such as zinc zirconate titanate (PZT), barium titanate (BaTiO₃), and the like, can be preferably used. Alternatively, the piezoelectric material may be a material in which piezoelectric ceramic particles are dispersed in a resin material. Still alternatively, piezoelectric materials other than the piezoelectric ceramic materials (e.g., piezoelectric single crystal materials, such as quartz) may be used. The thickness of the vibrator layer 11 is not particularly limited.

Note that the vibrator layer is not limited to the exemplified vibrator layer. An organic actuator with the use of PVDF (polyvinylidene fluoride) or ion conductive polymers or a layer including a small induction coil may be used as the vibrator layer. Since PVDF is one type of piezoelectric material, an organic actuator with the use of PVDF can be referred to as a piezoelectric layer.

Each of the first electrode 12 and the second electrode 13 can be made of a variety of known electrically-conductive materials and, for example, can be suitably made of a metal such as copper (Cu), nickel (Ni), silver (Ag), gold (Au), an alloy such as Al—Nd alloy (aluminum neodymium alloy), or a metal oxide such as indium tin oxide (ITO). The thickness of the first electrode 12 and the second electrode 13 is not particularly limited.

The first electrode 12 is electrically coupled with the unit circuit 20. The second electrode 13 is electrically coupled with the reference voltage source GND. When a voltage is applied between the first electrode 12 and the second electrode 13, the piezoelectric layer 11 undergoes deformation. More specifically, the piezoelectric layer 11 expands and contracts in the thickness direction so that vibration occurs.

The unit circuit 20 drives the tactile sensation presenting section 10. Hereinafter, the configuration of the unit circuit 20 is described. The unit circuit 20 includes a plurality of transistors as switching elements as will be described later. The transistors included in the unit circuit 20 are typically TFTs. In the example described hereinafter, the switching elements included in the unit circuit 20 are n-type TFTs. Note that electrical connection of the source and drain of a p-type TFT is opposite to that of the source and drain of a n-type TFTs.

The unit circuit 20 includes a plurality of sub-circuits 21 electrically coupled in parallel with one another. In the illustrated example, the unit circuit 20 includes three sub-circuits 21, specifically the first sub-circuit 21A, the second sub-circuit 21B and the third sub-circuit 21C.

Each of the plurality of sub-circuits 21 includes the first internal node N1, the second internal node N2, the first transistor Ts, the second transistor Tp, the third transistor Tr, the first capacitor Cs, and the second capacitor Cbst. In the following description, for the components of the first sub-circuit 21A, the branch number “_1” may be affixed at the end of the reference symbol (for example, the first transistor Ts of the first sub-circuit 21A may be denoted as “first transistor Ts_”). Likewise, for the components of the second sub-circuit 21B, the branch number “_2” may be affixed at the end of the reference symbol, and for the components of the third sub-circuit 21C, the branch number “_3” may be affixed at the end of the reference symbol.

The gate of the first transistor Ts is supplied with a gate signal. Herein, the first transistor Ts_1 of the first sub-circuit 21A, the first transistor Ts_2 of the second sub-circuit 21B, and the first transistor Ts_3 of the third sub-circuit 21C are supplied with different gate signals S1, S2 and S3. The source of the first transistor Ts is electrically coupled with the data voltage line DL and supplied with the data voltage Vd that has a predetermined amplitude. Herein, the first transistors Ts of the plurality of sub-circuits 21 are supplied with the data voltage Vd from the common data voltage line DL. The drain of the first transistor Ts is electrically coupled with the second internal node N2. In the following description, the first transistor Ts is also referred to as “set transistor”.

The gate of the second transistor Tp is electrically coupled with the second internal node N2. The source of the second transistor Tp is electrically coupled with the driving voltage line PL and supplied with the driving voltage Vp that has a greater amplitude than that of the data voltage Vd. Herein, the driving voltage Vp supplied to the second transistor Tp is a pulse voltage (square wave). The drain of the second transistor Tp is electrically coupled with the first internal node N1. In the following description, the second transistor Tp is also referred to as “driving transistor”.

The gate of the third transistor Tr is supplied with the initialization signal Sini. The source of the third transistor Tr is electrically coupled with the reference voltage source GND. The drain of the third transistor Tr is electrically coupled with the first internal node N1. In the following description, the third transistor Tr is also referred to as “reset transistor”.

The first end of the second capacitor Cbst is electrically coupled with the second internal node N2. The second end of the second capacitor Cbst is electrically coupled with the first internal node N1. Therefore, it can be said that the second capacitor Cbst is located between the first internal node N1 and the second internal node N2. In the following description, the second capacitor Cbst is also referred to as “bootstrap capacitor”.

The first end of the first capacitor Cs is electrically coupled with the first internal node N1. The second end of the first capacitor Cs is electrically coupled with the tactile sensation presenting section 10. Therefore, it can be said that the first capacitor Cs is located between the first internal node N1 and the tactile sensation presenting section 10. Herein, the first capacitor Cs_1 of the first sub-circuit 21A, the first capacitor Cs_2 of the second sub-circuit 21B, and the first capacitor Cs_3 of the third sub-circuit 21C have equal capacitance values. That is, Cs_1=Cs_2=Cs_3=(⅓)·Cst holds where Cs_1, Cs_2 and Cs_3 are the capacitance values of the first capacitors Cs_1, Cs_2 and Cs_3, respectively, and Cst is the sum of the capacitance values. In the following description, the first capacitor Cs is also referred to as “storage capacitor”.

The unit circuit 20 further includes the fourth transistor Tr′ in addition to the plurality of sub-circuits 21 that have been previously described. The gate of the fourth transistor Tr′ is supplied with the initialization signal Sini. The source of the fourth transistor Tr′ is electrically coupled with the reference voltage source GND. The drain of the fourth transistor Tr′ is electrically coupled with the second end of the first capacitor Cs of each of the sub-circuits 21. In the following description, the fourth transistor Tr′ is also referred to as “additional reset transistor”.

FIG. 5 is a diagram showing an arrangement example of data voltage lines DL for supplying the data voltages Vd to respective ones of the unit circuits 20 and gate signal lines GL for supplying the gate signals S1, S2, S3 to respective ones of the unit circuits 20. In the example shown in FIG. 5, the plurality of unit regions UR are arrayed in n rows and m columns.

As shown in FIG. 5, a plurality of data voltage lines DL extend in the column direction, and a single data voltage line DL is allocated to each unit region column. Note that, in FIG. 5, the data voltages Vd supplied to the first column, the second column, the third column, . . . and the m^{th} column are denoted as Vd(1), Vd(2), Vd(3), . . . and Vd(m), respectively. Also, as shown in FIG. 5, a plurality of gate signal lines GL extend in the row direction, and three gate signal lines GL are allocated to each unit region row. Note that, in FIG. 5, the gate signals S1 supplied to the first row, the second row, the third row, . . . and the n^{th} row are denoted as S1(1), S1(2), S1(3), . . . and S1(n), respectively. Likewise, the gate signals S2 supplied to the first row, the second row, the third row, . . . and the n^{th} row are denoted as S2(1), S2(2), S2(3), . . . and S2(n), respectively, and the gate signals S3 supplied to the first row, the second row, the third row, . . . and the n^{th} row are denoted as S3(1), S3(2), S3(3) . . . and S3(n), respectively.

In the tactile sensation presenting device 100 according to an embodiment of the present invention, by ON/OFF control of the driving transistors Tp of the plurality of sub-circuits 21 (in other words, by suitably selecting the combination of some of the driving transistors Tp_1, Tp_2, Tp_3 which are to be set to the ON state), the effective capacitance value of the capacitance connected to the tactile sensation presenting section 10 (the storage capacitors Cs of the plurality of sub-circuits 21) is varied, whereby the amplitude of the applied voltage Vpz to the tactile sensation presenting section 10 can be controlled. Therefore, multi-level tactile sensation presentation can be suitably realized.

With the configuration example illustrated in FIG. 4, 4-level tactile sensation presentation from Level 0 to Level 3 can be realized. Note that, in the following description, Level Y in X-level tactile sensation presentation may be represented as “Level Y/X”. For example, Level 2 in 4-level tactile sensation presentation may be represented as “Level 2/4”.

When all of the three driving transistors Tp of the unit circuit 20 are OFF, the tactile sensation presentation level is “Level 0”. When one of the three driving transistors Tp is ON while the other two are OFF, the tactile sensation presentation level is “Level 1”. When two of the three driving transistors Tp are ON while the other one is OFF, the tactile sensation presentation level is “Level 2”. When all of the three driving transistors Tp are ON, the tactile sensation presentation level is “Level 3”.

The applied voltage Vpz to the tactile sensation presenting section 10 can be expressed as follows by the sum of the capacitance values of the storage capacitors Cs_1, Cs_2 and Cs_3, Cst, the capacitance value of the tactile sensation presenting section 10 (piezoelectric capacitance), Cpz, and the driving voltage Vp:

$$Vpz = [ \{ ( k / 3 ) \cdot Cst \} / \{ ( k / 3 ) \cdot Cst + Cpz \} ] \cdot Vp$$

where k is the presented level (0 to 3).

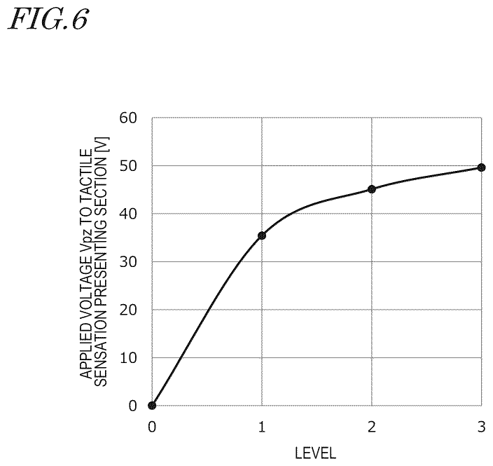

FIG. 6 is a graph showing the relationship between the presented levels and the applied voltage Vpz to the tactile sensation presenting section 10 in the case of Vp=62 [V], Cpz=15 [pF], and Cst=60 [pF]. In the example shown in FIG. 6, the applied voltage Vpz to the tactile sensation presenting section 10 is 0 V for Level 0, about 35 V for Level 1, about 45 V for Level 2, and about 50 V for Level 3.

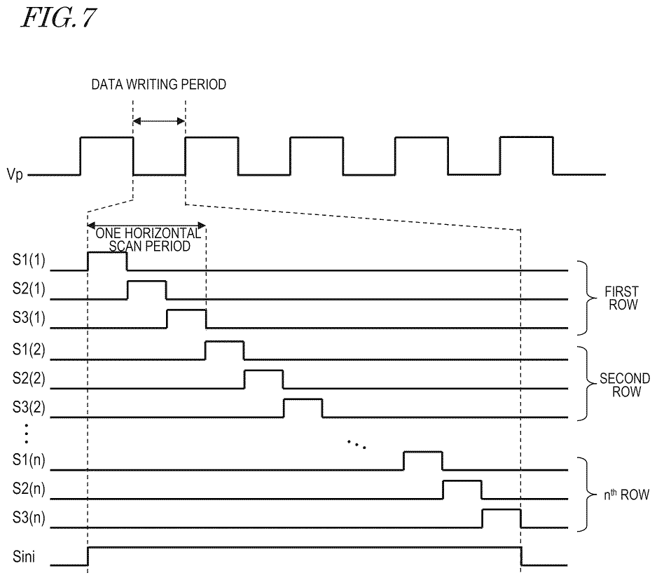

FIG. 7 is a timing chart showing an example of the driving voltage Vp, the gate signals S1, S2, S3, and the initialization signal Sini.

As shown in FIG. 7, the driving voltage Vp is a pulse voltage. In a period where the driving voltage Vp is at the low level, writing of data into the active region AR is performed. In the data writing period, the unit region rows are sequentially scanned in the order of the first row, the second row, . . . and the n^{th} row. In the illustrated example, in the period where each unit region row is scanned (one horizontal scan period), the gate signals S1, S2, S3 sequentially transition to the high level, and therefore, the set transistors Ts_1, Ts_2, Ts_3 are sequentially set to the ON state in one horizontal scan period. Although not shown herein, the data voltage Vd can be a binary signal for selection of ON/OFF of the driving transistors Tp_1, Tp_2, Tp_3. The initialization signal Sini is at the high level in the data writing period but is at the low level in the other periods.

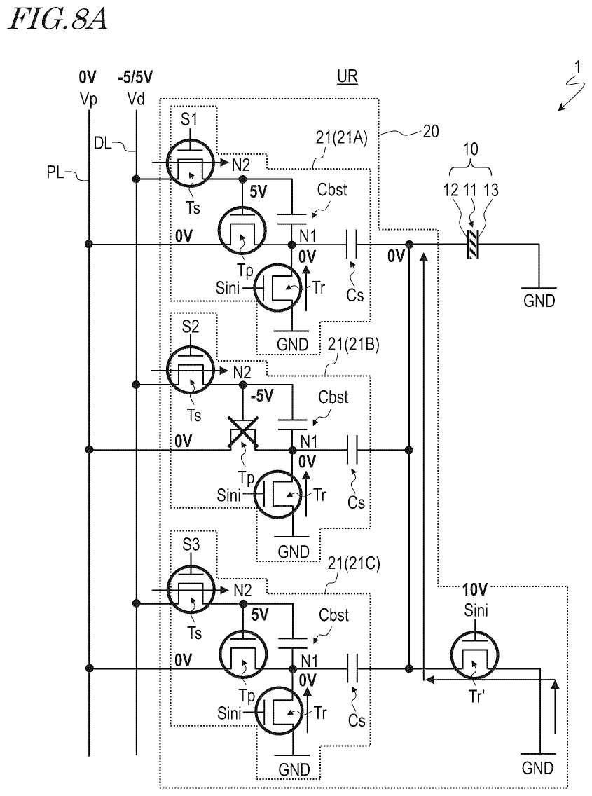

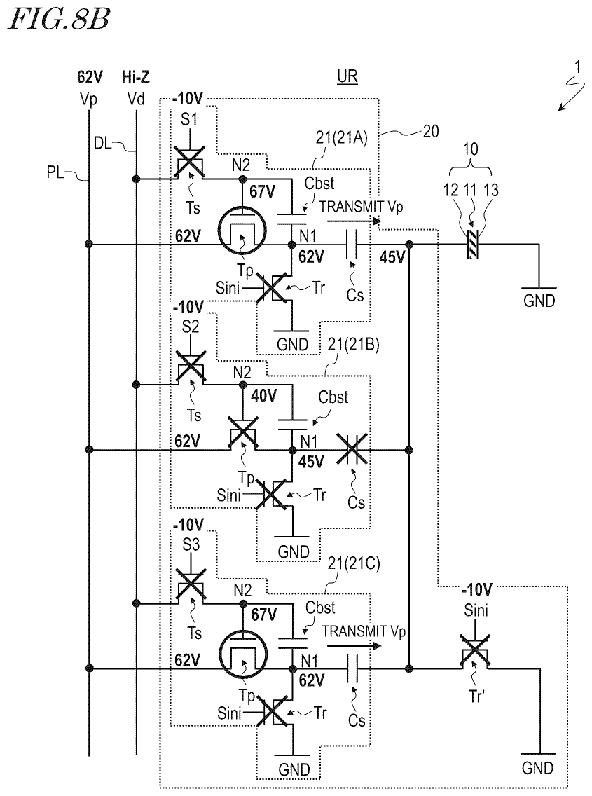

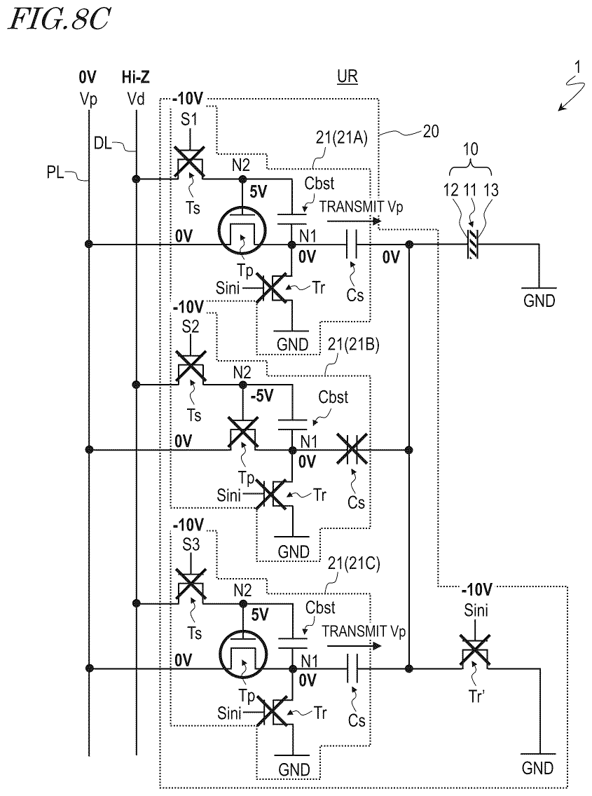

Now, an example of the operation of the tactile sensation presenting device 100 (the tactile sensation presenting element 1) is described with reference to FIG. 8A, FIG. 8B and FIG. 8C. In the example described herein, tactile sensation presentation at Level 2/4 is performed based on the voltage values and the capacitance values shown in TABLE 1. In FIG. 8A, FIG. 8B and FIG. 8C, circles (O) placed over transistors indicate that the transistors are in the ON state, and crosses (X) placed over transistors indicate that the transistors are in the OFF state. Crosses (X) placed over some of the storage capacitors Cs indicate that the storage capacitors Cs do not effectively function as capacitance connected to the tactile sensation presenting section 10. Further, in FIG. 8A, FIG. 8B and FIG. 8C, the potentials at some locations in the circuit are shown.

TABLE 1

| | |
|---|---|
| Vd | −5 V/5 V |
| Vp | 0 V/62 V |
| S1, S2, S3 | −10 V/10 V |
| Sini | −10 V/10 V |
| Cpz | 15 pF |
| Cst | 60 pF |
| Cs_1, Cs_2, Cs_3 | 20 pF |

### [First Step: Reset and Data Writing (FIG. 8A)]

First, as shown in FIG. 8A, in the data writing period (where the driving voltage Vp is at the low level (=0 V)), the set transistors Ts_1, Ts_2, Ts_3 of the first sub-circuit 21A, the second sub-circuit 21B and the third sub-circuit 21C are sequentially set to the ON state, and writing of data into the second internal node N2 is performed. In this example, a data voltage Vp for setting the driving transistor Tp to the ON state (specifically, 5 V) is written into the second internal nodes N2 of the first sub-circuit 21A and the third sub-circuit 21C while a data voltage Vp for setting the driving transistor Tp to the OFF state (specifically, −5 V) is written into the second internal node N2 of the second sub-circuit 21B.

Also, under such circumstances, all of the reset transistors Tr_1, Tr_2 and Tr_3 of the first sub-circuit 21A, the second sub-circuit 21B and the third sub-circuit 21C and the additional reset transistor Tr′ are in the ON state so that the nodes other than the second internal nodes N2 are reset to 0 V.

### [Second Step: Application of High Level Driving Voltage Vp (FIG. 8B)]

After the end of the data writing period, the driving voltage Vp transitions to the high level (i.e., 62 V) while, as shown in FIG. 8B, all of the reset transistors Tr_1, Tr_2 and Tr_3 and the additional reset transistor Tr′ turn to the OFF state. Under such circumstances, all of the set transistors Ts_1, Ts_2, Ts_3 are also in the OFF state and, therefore, all of the second internal nodes N2_1, N2_2 and N2_3 are in a floating state. Therefore, the electrical charge accumulated in the bootstrap capacitor Cbst serves to maintain the voltage applied across the bootstrap capacitor Cbst, i.e., the potential difference between the first internal node N1 and the second internal node N2. Since the driving transistor Tp_1 of the first sub-circuit 21A and the driving transistor Tp_3 of the third sub-circuit 21C are in the ON state, as the source potentials of these elements rise, the potentials of the second internal nodes N2_1 and N2_3 also rise accordingly. Specifically, the source potentials of the driving transistors Tp_1 and Tp_3 rise to 62 V and, accordingly, the potentials of the second internal nodes N2_1 and N2_3 rise to 67 V. Since this bootstrap serves to maintain the ON state of the driving transistor Tp_1 and the driving transistor Tp_3 of the third sub-circuit 21C, the driving voltage Vp transmitted to the tactile sensation presenting section 10 is two thirds (⅔) of its original magnitude (i.e., about 45 V).

### [Third Step: Application of Low Level Driving Voltage Vp (FIG. 8C)]

Next, each of the nodes returns to the state of the first step as shown in FIG. 8C according to transition of the driving voltage Vp to the low level (i.e., 0 V). The driving voltage Vp at the low level (i.e., 0 V) is transmitted to the tactile sensation presenting section 10.

Thus, in the tactile sensation presenting device 100 according to an embodiment of the present invention, the effective capacitance value of the capacitance connected to the tactile sensation presenting section 10 is changed by controlling the ON/OFF state of the driving transistors Tp of the plurality of sub-circuits 21, whereby the amplitude of the applied voltage Vpz to the tactile sensation presenting section 10 can be controlled. This can be rephrased as follows: in the tactile sensation presenting device 100, the applied voltage to the tactile sensation presenting section 10 is controlled by controlling the potential of the first internal node N1 in each of the plurality of sub-circuits 21 (see also the potentials of the first internal nodes N1 shown in FIG. 8A, FIG. 8B and FIG. 8C).

In the tactile sensation presenting device 100 according to an embodiment of the present invention, as seen from the above-described operation examples, the signal driven with a relatively high voltage is only the driving voltage Vp, and the other signals can be driven with relatively low voltages. Therefore, in the driving circuit for driving the data voltage line DL, a general-purpose driver IC for display devices can be used, so that the manufacturing cost can be reduced. Further, the driving circuit for driving the data voltage line DL can be realized by a binary driver for controlling the ON/OFF state of transistors, so that the manufacturing cost can be further reduced.

In the tactile sensation presenting device 100 according to an embodiment of the present invention, the on-voltage applied to each of the transistors of the unit circuit 20 (gate-source voltage Vgs) can be kept low (in the above-described example, the gate-source voltage Vgs of the transistors in the OFF state is −5 V, and the gate-source voltage Vgs of the transistors in the ON state is 5 V). Therefore, a large shift in the threshold voltage of the transistors of the unit circuit 20 and breakdown of the transistors of the unit circuit 20 can be prevented.

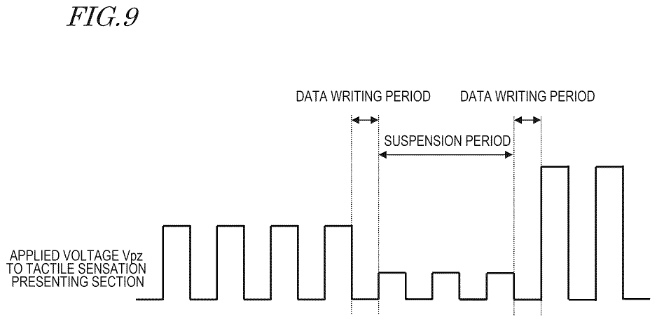

FIG. 9 is a graph showing the relationship between the applied voltage Vpz to the tactile sensation presenting section 10 and the data writing period. As seen from FIG. 9, writing of data is performed in periods where the driving voltage Vp is at the low level immediately before the amplitude of the applied voltage Vpz is changed. In the other periods (in the following description, referred to as “suspension periods”), gate scanning (scanning of unit region columns) is suspended so that the driver for driving the data signal line DL can be set to a high impedance (Hi-Z) state. That is, in the suspension periods, only the driving voltage line PL for supplying the driving voltage Vp needs to be driven while the other signals can be maintained in a suspended state, so that low power consumption can be realized.

In the above-described suspension periods, from the viewpoint of suppressing leakage of the electrical charge from the second internal node N2 and other elements of the unit circuit 20 in order to maintain a constant potential, it is preferred that each of the transistors of the unit circuit 20 is an oxide semiconductor TFT that includes an oxide semiconductor layer as the active layer.

Note that in the example shown in FIG. 4 the unit circuit 20 includes three sub-circuits 21, although the number of sub-circuits 21 is not limited to three. The number of sub-circuits 21 may be two or may be four or more.

In the example shown in FIG. 4, each of the sub-circuits 21 includes a bootstrap capacitor (second capacitor) Cbst, although the configuration of the sub-circuits 21 is not limited to this example. When the driving transistor Tp has sufficiently large capacitance (for example, when the size of the driving transistor Tp is large), the capacitance of the driving transistor Tp can be used instead of the bootstrap capacitor Cbst, so that the bootstrap capacitor Cbst may be omitted.

Next, a variation example of the tactile sensation presenting device 100 is described.

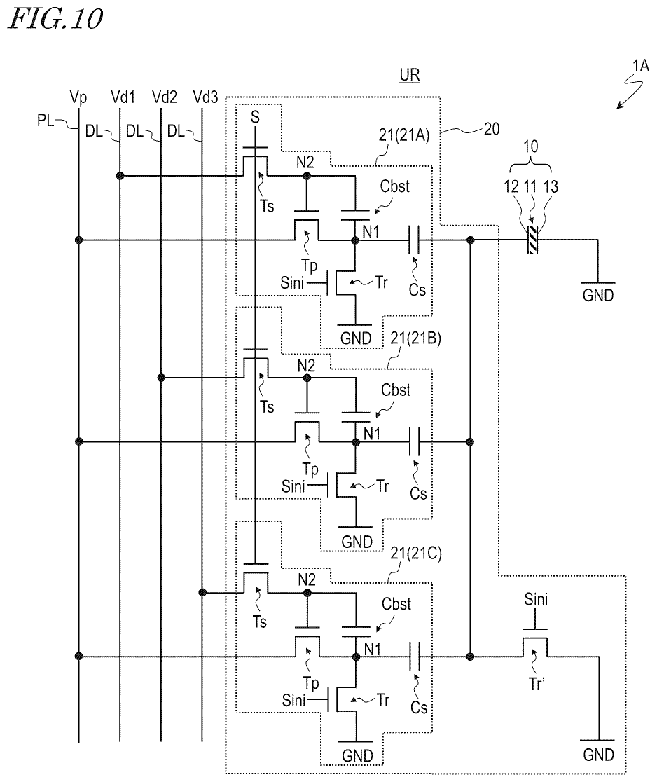

The tactile sensation presenting device 100 may include a tactile sensation presenting element 1A shown in FIG. 10 in place of the tactile sensation presenting element 1 shown in FIG. 4.

In the tactile sensation presenting element 1 shown in FIG. 4, the first transistors Ts_1, Ts_2 and Ts_3 of the first sub-circuit 21A, the second sub-circuit 21B and the third sub-circuit 21C are supplied with different gate signals S1, S2 and S3. Also, the first transistors Ts_1, Ts_2 and Ts_3 are supplied with the data voltage Vd from a common data voltage line DL.

In comparison, in the tactile sensation presenting element 1A shown in FIG. 10, the first transistors Ts_1, Ts_2 and Ts_3 of the first sub-circuit 21A, the second sub-circuit 21B and the third sub-circuit 21C are supplied with a common gate signal S. Also, the first transistors Ts_1, Ts_2 and Ts_3 are supplied with the data voltages Vd1, Vd2 and Vd3, respectively, from different data voltage lines DL.

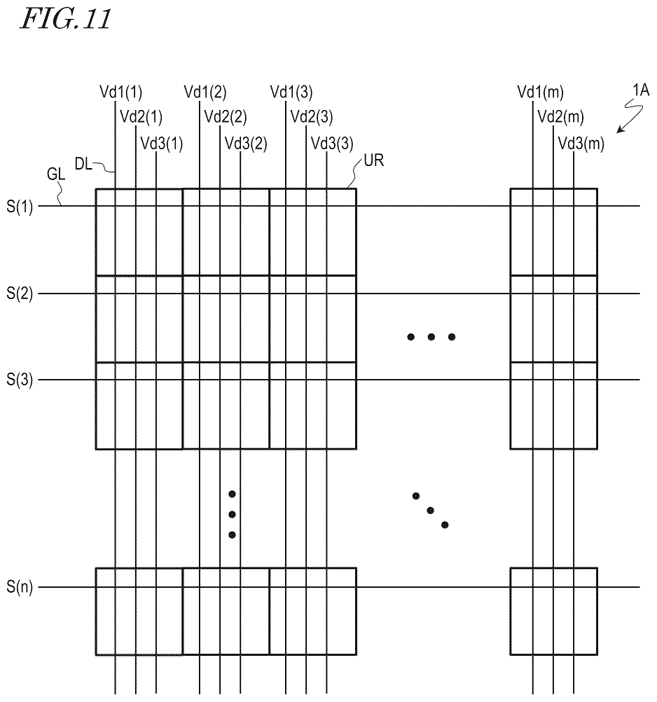

FIG. 11 is a diagram showing an arrangement example of data voltage lines DL for supplying the data voltages Vd1, Vd2 and Vd3 to respective ones of the unit circuits 20 of the tactile sensation presenting element 1A and gate signal lines GL for supplying the gate signals S to respective ones of the unit circuits 20.

In the tactile sensation presenting element 1A, three data voltage lines DL are allocated to each unit region column as shown in FIG. 11. Note that, in FIG. 11, the data voltages Vd1 supplied to the first column, the second column, the third column, . . . and the m^{th} column are denoted as Vd1(1), Vd1(2), Vd1(3), . . . and Vd1(m), respectively. Likewise, the data voltages Vd2 supplied to the first column, the second column, the third column, . . . and the m^{t}h column are denoted as Vd2(1), Vd2(2), Vd2(3), . . . and Vd2(m), respectively. The data voltages Vd3 supplied to the first column, the second column, the third column, . . . and the m^{t}h column are denoted as Vd3(1), Vd3(2), Vd3(3), . . . and Vd3(m), respectively. In the tactile sensation presenting element 1A, a single gate signal line GL is allocated to each unit region row. Note that, in FIG. 11, the gate signals S supplied to the first row, the second row, the third row, . . . and the n^{th} row are denoted as S(1), S(2), S(3), . . . and S(n), respectively.

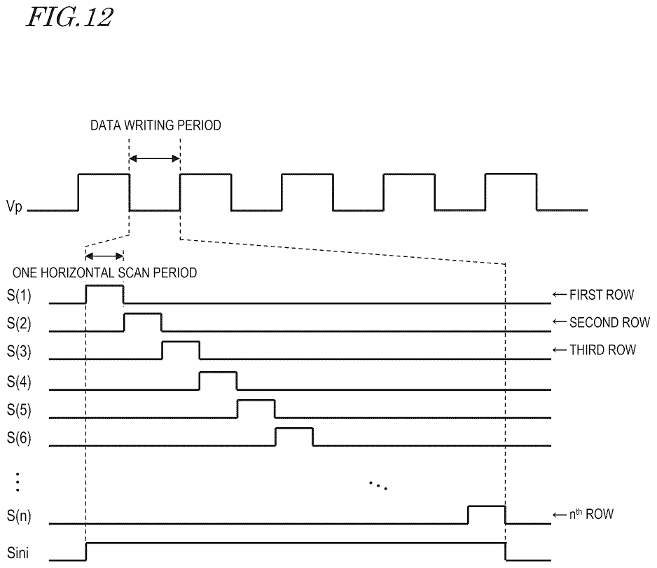

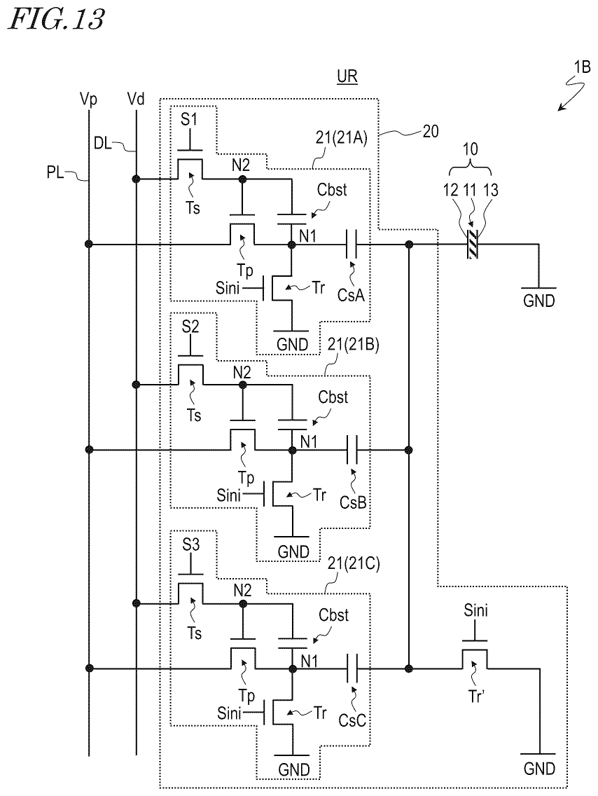

FIG. 12 is a timing chart showing an example of the driving voltage Vp, the gate signals S, and the initialization signal Sini in the tactile sensation presenting element 1A.

As shown in FIG. 12, writing of data into the active region AR is performed in a period where the driving voltage Vp is at the low level. In the data writing period, the unit region rows are sequentially scanned in the order of the first row, the second row, . . . and the n^{th} row. In the example shown in FIG. 12, in a period where the unit region rows are scanned (one horizontal scan period), the set transistors Ts_1, Ts_2, Ts_3 are simultaneously turned to the ON state by the gate signal S, and the ON/OFF state of the driving transistors Tp_1, Tp_2, Tp_3 is selected according to the potentials of the data voltages Vd1, Vd2 and Vd3.

As described above, in the tactile sensation presenting element 1A shown in FIG. 10, driving is performed such that the set transistors Ts_1, Ts_2, Ts_3 are simultaneously turned to the ON state and, therefore, writing of data is faster than that in the tactile sensation presenting element 1 shown in FIG. 4. Thus, the tactile sensation presenting element 1A is more advantageous in terms of driving at high frequencies and increasing the resolution of the active region AR.

The tactile sensation presenting device 100 may include a tactile sensation presenting element 1B shown in FIG. 13. In the tactile sensation presenting element 1B shown in FIG. 13, the storage capacitor CsA of the first sub-circuit 21A, the storage capacitor CsB of the second sub-circuit 21B, and the storage capacitor CsC of the third sub-circuit 21C have different capacitance values. The capacitance values of the storage capacitors CsA, CsB and CsC (which are denoted as “CsA”, “CsB” and “CsC”, respectively) are set so as to satisfy the relationship of, for example, CsA=2·CsB=4·CsC. This relationship can be rephrased as CsA=(½)·Csv, CsB=(¼)·Csv, CsC=(⅛)·Csv where Csv is twice the capacitance value CsA.

Since the storage capacitors CsA, CsB and CsC of the plurality of sub-circuits 21 have different capacitance values, tactile sensation presentation over a greater number of levels can be realized with an equal or small circuit scale as compared with a configuration where the storage capacitors CsA, CsB and CsC do not have different capacitance values (a configuration where the storage capacitors Cs_1, Cs_2 and Cs_3 have equal capacitance values such as in the tactile sensation presenting element 1 shown in FIG. 4). Specifically, tactile sensation presentation over 2^{X} levels can be realized where X is the number of sub-circuits 21. In the example shown in FIG. 13, the number of sub-circuits 21 is three and, therefore, tactile sensation presentation over 8 (=2³) levels can be realized.

In the case where the capacitance values of the storage capacitors CsA, CsB and CsC are set so as to satisfy the relationship of the illustrated example (i.e., CsA=(½)·Csv, CsB=(¼)·Csv, CsC=(⅛)·Csv), the applied voltage Vpz to the tactile sensation presenting section 10 is as follows:

$$Vpz = [ \{ ( k / 8 ) \cdot Csv \} / \{ ( k / 8 ) \cdot Csv + Cpz \} ] \cdot Vp$$

where k is the presented level (0 to 7).

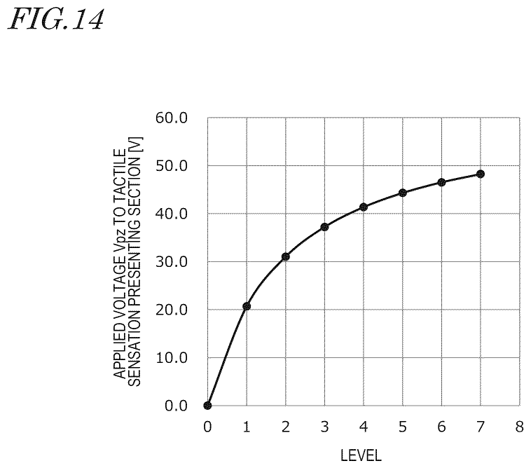

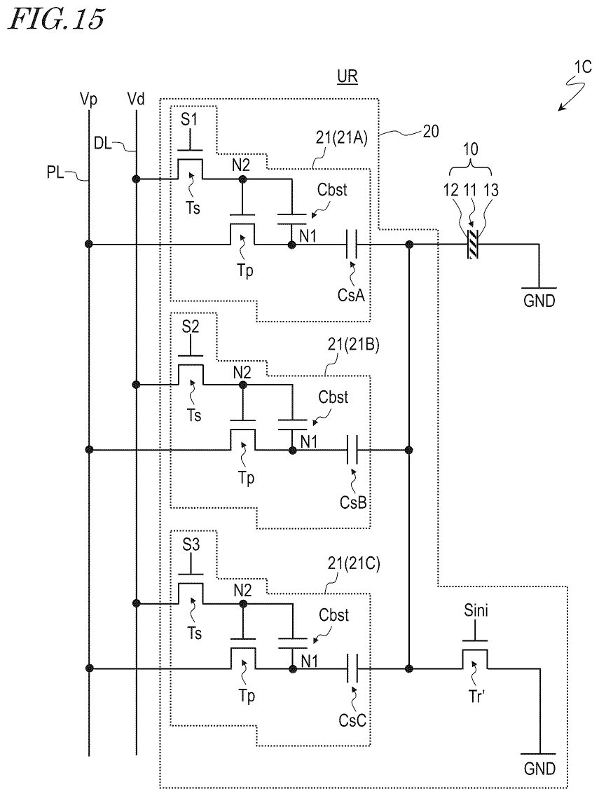

FIG. 14 is a graph showing the relationship between the presented levels and the applied voltage Vpz to the tactile sensation presenting section 10 in the case of Vp=62 [V], Cpz=15 [pF], and Csv=60 [pF]. In the example shown in FIG. 14, the applied voltage Vpz to the tactile sensation presenting section 10 is 0 V for Level 0, about 21 V for Level 1, about 31 V for Level 2, and about 37 V for Level 3. Also, the applied voltage Vpz is about 41 V for Level 4, about 44 V for Level 5, about 47 V for Level 6, and about 48 V for Level 7.

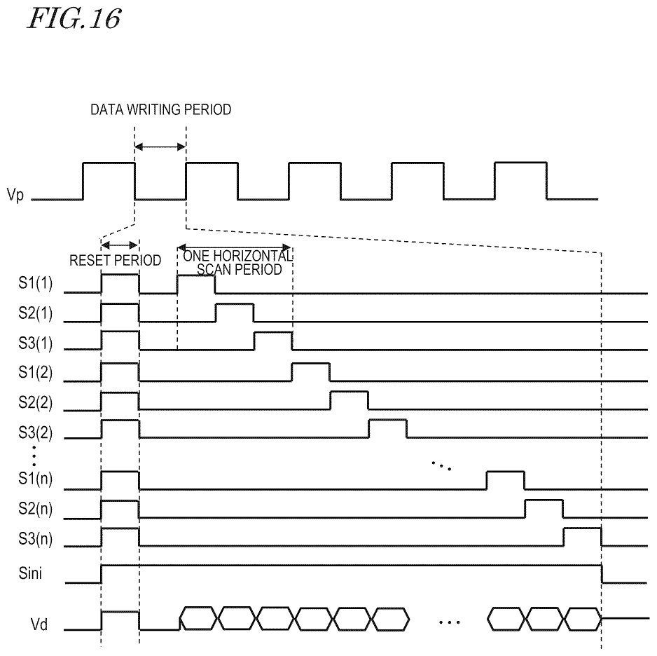

The tactile sensation presenting device 100 may include a tactile sensation presenting element 1C shown in FIG. 15. The tactile sensation presenting element 1C shown in FIG. 15 is different from the tactile sensation presenting element 1B shown in FIG. 13 in that each of the sub-circuits 21 does not include the reset transistor Tr. That is, each of the sub-circuits 21 of the tactile sensation presenting element 1C does not include a transistor for resetting the first internal node N1.

In the tactile sensation presenting element 1C, a reset period is provided before writing of data so that a reset operation can be carried out. In the reset period, the gate signals S1, S2 and S3 are set to the high level while the data voltage Vd is set to the high level, whereby the driving transistors Tp_1, Tp_2, and Tp_3 are turned to the ON state, so that the low-level driving voltage Vp (i.e., 0 V) can be written. Thus, in the tactile sensation presenting element 1C, resetting of the first internal node N1, which is realized by the reset transistors Tr_1, Tr_2 and Tr_3 in the tactile sensation presenting element 1B shown in FIG. 13, can be realized without the reset transistors Tr_1, Tr_2 and Tr_3. Thus, the circuit scale can be reduced and, therefore, the tactile sensation presenting element 1C is advantageous in terms of increasing the resolution and improving the manufacturing yield.

FIG. 16 is a timing chart showing an example of the driving voltage Vp, the gate signals S, the initialization signal Sini, and the data voltage Vd in the tactile sensation presenting element 1C.

In the example shown in FIG. 16, a reset period, which is common among all of the unit region rows, is provided before writing of data in the data writing period (a period where the driving voltage Vp is at the low level). In this reset period, the above-described reset operation is carried out.

In the example shown in FIG. 16, a common reset period is provided to all of the unit region rows, although the present invention is not limited to this example. The reset operation may be carried out before writing of data into each of the unit region rows. The reset operation may be carried out before writing of data into each of the sub-circuits 21.

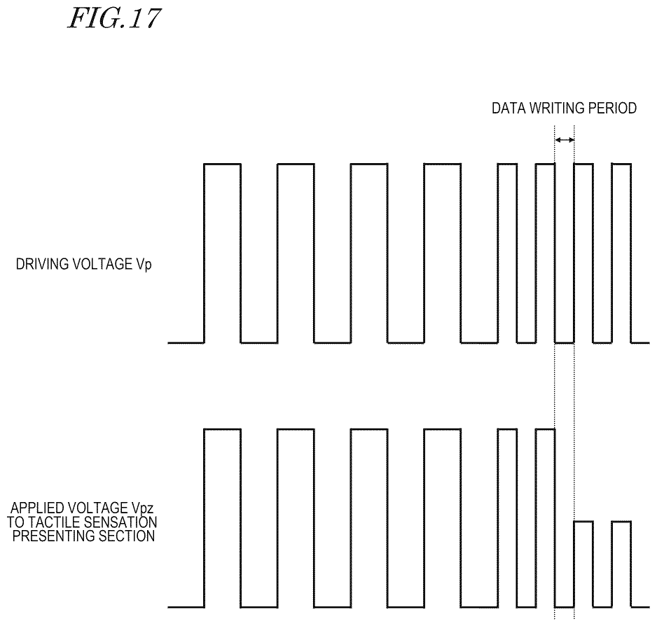

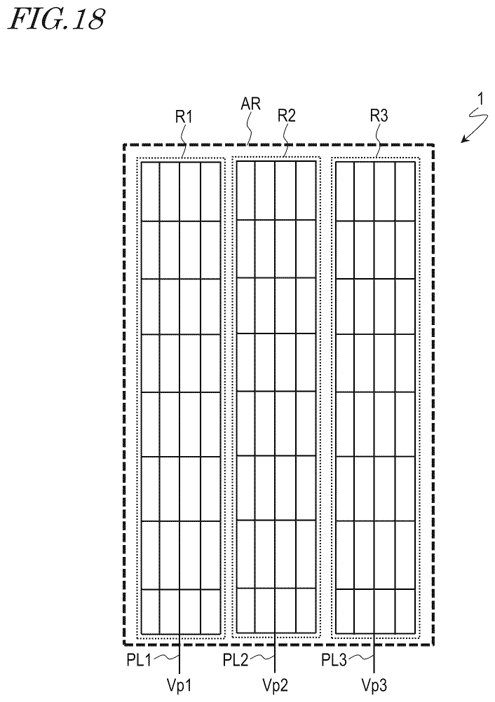

The tactile sensation presenting device 100 may be configured such that the frequency of the driving voltage Vp, which is a pulse voltage, is variable. FIG. 17 shows an example where the frequency of the driving voltage Vp changes. As shown in FIG. 17, by changing the frequency of the driving voltage Vp, the frequency of the applied voltage Vpz to the tactile sensation presenting section 10 can also be changed in synchronization with the change of the frequency of the driving voltage Vp.

Note that, when the frequency of the driving voltage Vp is changed, as a matter of course, the length of a period where the driving voltage Vp is at the low level (a period where the data writing period can be set) changes. Thus, when the frequency of the driving voltage Vp is variable, the tactile sensation presenting device 100 is configured such that writing of data is completed in the above-described period even in the case where the frequency of the driving voltage Vp is at the highest state.

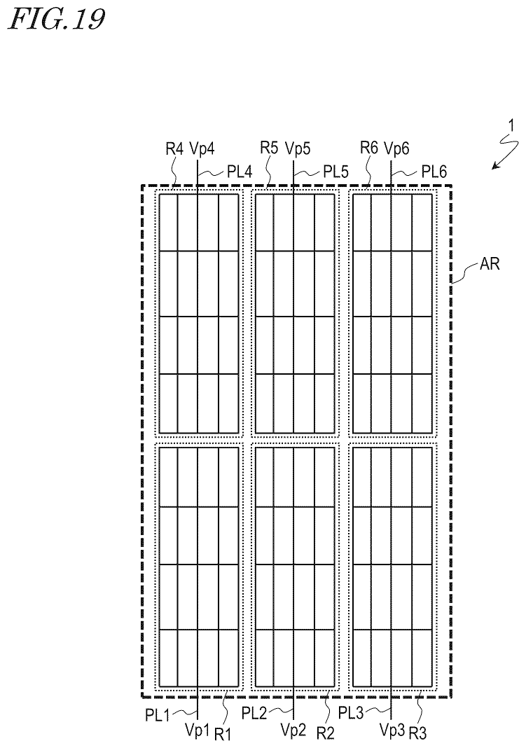

Supply of the driving voltage Vp may be, or may not be, uniform across the entire active region (tactile sensation presenting region) AR. That is, the active region AR may include a plurality of regions among which the driving voltage Vp supplied to the driving transistor Tp can be different. FIG. 18 and FIG. 19 show examples of such a configuration.

In the example shown in FIG. 18, the active region AR includes the first region R1, the second region R2 and the third region R3. The first region R1, the second region R2 and the third region R3 are arrayed along the row direction (more specifically, in one row and three columns).

The first region R1 is supplied with the driving voltage Vp1 via the driving voltage line PL1. The second region R2 is supplied with the driving voltage Vp2 via the driving voltage line PL2. The third region R3 is supplied with the driving voltage Vp3 via the driving voltage line PL3. The driving voltages Vp1, Vp2 and Vp3 can be different from one another.

In the example shown in FIG. 19, the active region AR includes the first region R1, the second region R2, the third region R3, the fourth region R4, the fifth region R5 and the sixth region R6. The first region R1, the second region R2, the third region R3, the fourth region R4, the fifth region R5 and the sixth region R6 are arrayed along the row direction and the column direction (more specifically, in two rows and three columns).

The first region R1 is supplied with the driving voltage Vp1 via the driving voltage line PL1. The second region R2 is supplied with the driving voltage Vp2 via the driving voltage line PL2. The third region R3 is supplied with the driving voltage Vp3 via the driving voltage line PL3. The fourth region R4 is supplied with the driving voltage Vp4 via the driving voltage line PL4. The fifth region R5 is supplied with the driving voltage Vp5 via the driving voltage line PL5. The sixth region R6 is supplied with the driving voltage Vp6 via the driving voltage line PL6. The driving voltages Vp1, Vp2, Vp3, Vp4, Vp5 and Vp6 can be different from one another.

As in the examples shown in FIG. 18 and FIG. 19, the active region AR is divided into a plurality of regions among which the driving voltage Vp can be different, so that vibrations at different frequencies can be present together in the active region AR, and therefore, tactile sensation presentation with a higher resolution can be realized.

Note that FIG. 18 shows an example where a plurality of regions among which the driving voltage Vp can be different are arrayed along the row direction and FIG. 19 shows an example where a plurality of regions among which the driving voltage Vp can be different are arrayed along the row direction and the column direction, although these regions may be arrayed along the column direction. The number of these regions is not limited to the examples shown in FIG. 18 and FIG. 19.

In the foregoing description, the tactile sensation presenting device 100 is a vibration type device, although a tactile sensation presenting device according to an embodiment of the present invention is not limited to the vibration type device but may be a type of tactile sensation presenting device which is capable of presenting tactile sensations by electrical stimulation (hereinafter, referred to as “electrical stimulation type”).

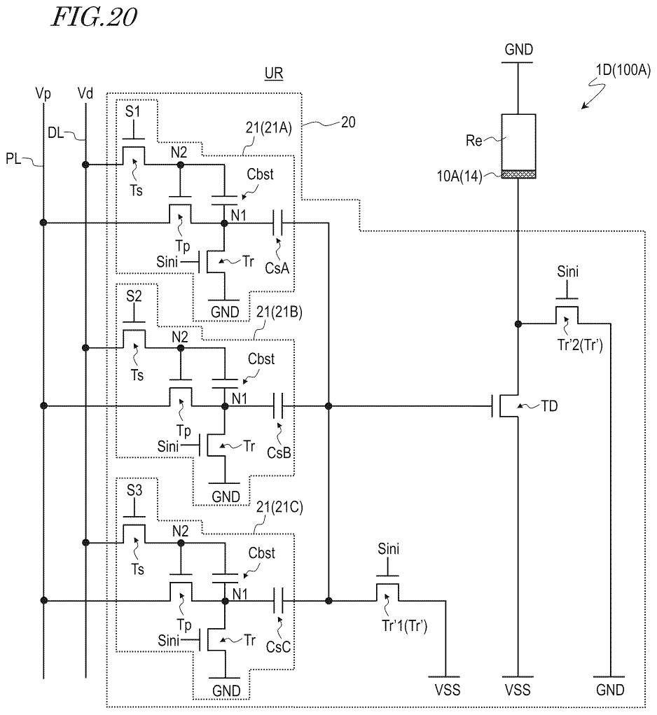

FIG. 20 shows an electrical stimulation type tactile sensation presenting device 100A. The tactile sensation presenting element 1D included in the tactile sensation presenting device 100A is different from the tactile sensation presenting element 1B shown in FIG. 13 in that the tactile sensation presenting element 1D includes a tactile sensation presenting section 10A that is capable of presenting tactile sensations by electrical stimulation. Herein, the tactile sensation presenting section 10A includes an electrode 14 that is in contact with the resistor Re. The resistor Re is, for example, a user's finger. The tactile sensation presenting element 1D is also different from the tactile sensation presenting element 1B shown in FIG. 13 in the points described below.

The unit circuit 20 of the tactile sensation presenting element 1D includes two fourth transistors (additional reset transistors) Tr′. The unit circuit 20 of the tactile sensation presenting element 1D further includes the fifth transistor TD.

The gate of the fifth transistor TD is electrically coupled with the second ends of the first capacitors CsA, CsB and CsC of the sub-circuits 21. The source of the fifth transistor TD is electrically coupled with the negative power supply VSS. The drain of the fifth transistor TD is electrically coupled with the tactile sensation presenting section 10A. In the following description, the fifth transistor TD is also referred to as “additional driving transistor”.

The additional reset transistor Tr′1, which is one of the two additional reset transistors Tr′, has a drain electrically coupled with the second ends of the second capacitors CsA, CsB and CsC of the sub-circuits 21, as does the additional reset transistor Tr′ of the tactile sensation presenting element 1B shown in FIG. 13. Note that, however, the source of the additional reset transistor Tr′1 is electrically coupled with the negative power supply VSS rather than the reference voltage source GND. The additional reset transistor Tr′2, which is the other one of the two additional reset transistors Tr′, has a source electrically coupled with the reference voltage source GND and a drain electrically coupled with the drain of the additional driving transistor TD. In the reset operation, these additional reset transistors Tr′1 and TR′2 initialize the gate voltage of the additional driving transistor TD to the potential of the negative power supply VSS and initialize the drain voltage of the additional driving transistor TD to the potential of the reference voltage source GND.

The tactile sensation presenting element 1D included in the tactile sensation presenting device 100A operates substantially in the same manner as the tactile sensation presenting element 1B shown in FIG. 13. Note that, however, in the tactile sensation presenting element 1D, a voltage whose magnitude is determined according to the presented level is applied to the gate of the additional driving transistor TD, and an electric current which is determined according to the difference between the gate voltage of the additional driving transistor TD and the source voltage of the additional driving transistor TD (the potential of the negative power supply VSS) flows through the path including the reference voltage source GND, the resistor Re (e.g., finger), the additional driving transistor TD, and the negative power supply VSS. It can also be said that the illustrated tactile sensation presenting device 100A controls the electric current flowing through the tactile sensation presenting section 10A by controlling the potential of the first internal node N1 in each of the plurality of sub-circuits 21.

Even the electrical stimulation type tactile sensation presenting device 100A can produce the same effects as those produced by the vibration type tactile sensation presenting device 100.

According to an embodiment of the present invention, a tactile sensation presenting device can be provided which can be realized at a reduced manufacturing cost even when the tactile sensation presenting section requires application of relatively high voltages. Embodiments of the present invention are suitably applicable to, for example, vibration type tactile sensation presenting devices.

This application is based on Japanese Patent Application No. 2024-211657 filed on Dec. 4, 2024, the entire contents of which are hereby incorporated by reference.

What is claimed is:

1. A tactile sensation presenting device having a plurality of unit regions in each of which presentation of tactile sensations can be independently controlled, the device comprising:
a tactile sensation presenting section provided in each of the plurality of unit regions, the tactile sensation presenting section being capable of presenting tactile sensations; and
a unit circuit electrically coupled with the tactile sensation presenting section, the unit circuit being capable of driving the tactile sensation presenting section,
wherein the unit circuit includes a plurality of sub-circuits electrically coupled in parallel with one another,
each of the plurality of sub-circuits includes
a first internal node, and
a first capacitor having a first end electrically coupled with the first internal node and a second end electrically coupled with the tactile sensation presenting section, and
an applied voltage to the tactile sensation presenting section or an electric current flowing through the tactile sensation presenting section is controlled by controlling a potential of the first internal node in each of the plurality of sub-circuits.

2. The tactile sensation presenting device of claim 1, wherein each of the plurality of sub-circuits further includes
a second internal node,
a first transistor having a source and a drain, one of the source and the drain being supplied with a data voltage having a predetermined amplitude while the other being electrically coupled with the second internal node, and
a second transistor having a gate, a source and a drain, the gate being electrically coupled with the second internal node, one of the source and the drain being supplied with a driving voltage having a greater amplitude than that of the data voltage while the other being electrically coupled with the first internal node.

3. The tactile sensation presenting device of claim 2, wherein each of the plurality of sub-circuits further includes a second capacitor having a first end electrically coupled with the second internal node and a second end electrically coupled with the first internal node.

4. The tactile sensation presenting device of claim 2, wherein each of the plurality of sub-circuits further includes a third transistor having a source and a drain, one of the source and the drain being electrically coupled with the first internal node while the other being electrically coupled with a reference voltage source.

5. The tactile sensation presenting device of claim 2, wherein each of the plurality of sub-circuits does not include a transistor for resetting the first internal node.

6. The tactile sensation presenting device of claim 2, wherein the unit circuit further includes a fourth transistor having a source and a drain, one of the source and the drain being electrically coupled with the second end of the first capacitor of each of the plurality of sub-circuits while the other being electrically coupled with a reference voltage source.

7. The tactile sensation presenting device of claim 2, wherein the first transistors of the plurality of sub-circuits are supplied with the data voltage from a common data voltage line.

8. The tactile sensation presenting device of claim 2, wherein the first transistors of the plurality of sub-circuits are supplied with the data voltage from different data voltage lines.

9. The tactile sensation presenting device of claim 2, wherein
the driving voltage supplied to the second transistor is a pulse voltage, and
a frequency of the pulse voltage is variable.

10. The tactile sensation presenting device of claim 2, wherein
the tactile sensation presenting device has a tactile sensation presenting region including the plurality of unit regions, and
the tactile sensation presenting region includes a plurality of regions among which the driving voltage supplied to the second transistor can be different.

11. The tactile sensation presenting device of claim 2, wherein each of the first transistor and the second transistor is an oxide semiconductor TFT including an oxide semiconductor layer.

12. The tactile sensation presenting device of claim 1, wherein the first capacitors of the plurality of sub-circuits have equal capacitance values.

13. The tactile sensation presenting device of claim 1, wherein the first capacitors of the plurality of sub-circuits have different capacitance values.

14. The tactile sensation presenting device of claim 1, wherein the plurality of sub-circuits included in the unit circuit are three or more sub-circuits.

15. The tactile sensation presenting device of claim 1, wherein the tactile sensation presenting section includes
a vibrator layer, and
a first electrode and a second electrode located opposite to each other with the vibrator layer interposed therebetween.

16. The tactile sensation presenting device of claim 15, wherein the vibrator layer is a piezoelectric layer that is made of a piezoelectric material.

17. The tactile sensation presenting device of claim 1, wherein the tactile sensation presenting section is capable of presenting tactile sensations by electrical stimulation.
